(19) United States
(12) Patent Application Publication
(10) Pub. No.: US 2013/0100329 A1
(43) Pub. Date: Apr. 25, 2013

(54) IMAGE PICKUP APPARATUS

(71) Applicant: Sanyo Electric Co., Ltd., Moriguchi City (JP)

(72) Inventors: Kazuhiro Kojima, Osaka City (JP); Toshitaka Kuma, Osaka City (JP); Masaaki Ueda, Katano City (JP); Yuki Inagaki, Daito City (JP)

(73) Assignee: SANYO ELECTRIC CO., LTD., Moriguchi City (JP)

(21) Appl. No.: 13/650,637

(22) Filed: Oct. 12, 2012

(30) Foreign Application Priority Data
Oct. 21, 2011 (JP) 2011-231555

(51) Int. Cl. H04N 5/222; H04N 5/225

(52) U.S. Cl. 348/333.01; 348/207.99; 348/E05.022

(57) ABSTRACT

An image pickup apparatus includes an image pickup portion which generates an image signal of a subject, a scenario setting portion which sets a photography scenario defining a plurality of reference scenes to be photographed, a verifying portion which verify photography scene of the image pickup portion with each of the reference scenes, a managing portion which manages a photography completion status of an image corresponding to each of the reference scenes, and a notification portion which performs notification corresponding to a result of verification by the verifying portion and a result of management by the managing portion.

### CROSS-REFERENCE TO RELATED APPLICATIONS

This nonprovisional application claims priority under 35 U.S.C. §119(a) on Patent Application No. 2011-231555 filed in Japan on Oct. 21, 2011, the entire contents of which are hereby incorporated by reference.

### BACKGROUND OF THE INVENTION

1. Field of the Invention

The present invention relates to an image pickup apparatus such as a digital camera.

2. Description of Related Art

There is proposed a method of generating images having a story (narrative images) using a digital camera. In this method, a photographer first selects a desired scenario (for example, home party) among a plurality of scenarios recorded in a digital camera. In the selected scenario, there are defined a plurality of reference scenes. The photographer photographs a moving image in a situation seemed to match with each reference scene and manually associates the taken moving image with any one of reference scenes. After completing photography of all reference scenes, it is possible to reproduce the taken moving images in an appropriate order along the selected scenario.

By the above-mentioned method, it is possible to collect moving images along the photographer's desired scenario. However, the photographer has to decide the situation under which the moving images are to be photographed, and hence the photographer may overlook a chance of photography corresponding to the desired scenario. As a result, a necessary photography chance may be missed so that desired images cannot be collected.

### SUMMARY OF THE INVENTION

An image pickup apparatus according to the present invention includes an image pickup portion which generates an image signal of a subject, a scenario setting portion which sets a photography scenario defining a plurality of reference scenes to be photographed, a verifying portion which verify photography scene of the image pickup portion with each of the reference scenes, a managing portion which manages a photography completion status of an image corresponding to each of the reference scenes, and a notification portion which performs notification corresponding to a result of verification by the verifying portion and a result of management by the managing portion.

### BRIEF DESCRIPTION OF THE DRAWINGS

FIG. 1 is a schematic entire block diagram of an image pickup apparatus according to an embodiment of the present invention.

FIG. 2 is an internal structural diagram of an image pickup portion illustrated in FIG. 1.

FIG. 3 is a diagram illustrating a structure of a specific photography scenario.

FIG. 4 is a diagram illustrating a plurality of template images belonging to a specific photography scenario.

FIG. 5 is a diagram illustrating a plurality of real photographed images acquired corresponding to a specific photography scenario.

FIG. 6 is a block diagram of a portion particularly related to an action in a scenario photography mode.

FIG. 7 is a diagram illustrating a manner in which a plurality of photography scenarios are classified into a plurality of categories.

FIG. 8 is a diagram illustrating a structure of one photography scenario.

FIG. 9 is a flowchart of the action in the scenario photography mode.

FIG. 10 is a diagram illustrating an example of management information managed by a photography completion status managing portion illustrated in FIG. 6.

FIG. 11 is a diagram illustrating an example of a scrapbook image including only a plurality of template images.

FIG. 12 is a diagram illustrating an example of a perforated image to be a base of the scrapbook image.

FIG. 13 is a diagram illustrating another example of the scrapbook image including only a plurality of template images.

FIGS. 14A and 14B are diagrams illustrating examples of displaying photography instruction notification.

FIG. 15 is a block diagram related to a composition change notification.

FIGS. 16A and 16B are diagrams illustrating examples of displaying composition change notification.

FIG. 17 is a diagram illustrating a display content example of a display portion.

FIG. 18 is a diagram illustrating a display content example of the display portion after one real photographed image is acquired.

FIG. 19 is a diagram illustrating an example of a display content transition of the display portion after one real photographed image is acquired.

FIGS. 20A and 20B are diagrams illustrating display content examples of the display portion before and after one real photographed image is acquired.

FIGS. 21A and 21B are diagrams illustrating examples of a method of simultaneously displaying a plurality of images.

FIGS. 22A to 22C are diagrams illustrating an example of a method of displaying the template image and the real photographed image.

FIG. 23 is a diagram illustrating an example of a method of displaying the template image and the real photographed image included in the scrapbook image.

FIG. 24 is a block diagram of a portion particularly related to an action in a scenario reproduction mode.

FIGS. 25A to 25C are diagrams illustrating examples (three examples) of reproducible scrapbook images.

FIGS. 26A and 26B are diagrams illustrating examples (two examples) of reproducible scrapbook images.

FIG. 27 is a diagram illustrating and example of reproduction content when a specific operation input is performed.

FIG. 28 is a diagram illustrating an example of reproduction content when a specific operation input is performed.

FIGS. 29A and 29B are diagrams illustrating an example of reproduction content when a specific operation input is performed.

FIGS. 30A and 30B are diagrams illustrating an example of reproduction content when a specific operation input is performed.

FIG. 31 is a block diagram of a portion particularly related to an action in a scenario editing mode.

FIGS. 32A and 32B are diagrams illustrating a scenario update status responding to a specific operation input.

FIGS. 33A and 33B are diagrams illustrating a scenario update status responding to a specific operation input.

### DETAILED DESCRIPTION OF THE PREFERRED EMBODIMENTS

Hereinafter, an example of an embodiment of the present invention is described in detail with reference to the attached drawings. In the drawings to be referred to, the same part is denoted by the same numeral or symbol, and overlapping description of the same part is omitted as a rule. Note that in this specification, for simple description, a name of information, a signal, a physical quantity, a status quantity, a member, or the like may be omitted or abbreviated when referring to the numeral or symbol indicating the information, the signal, the physical quantity, the status quantity, the member, or the like.

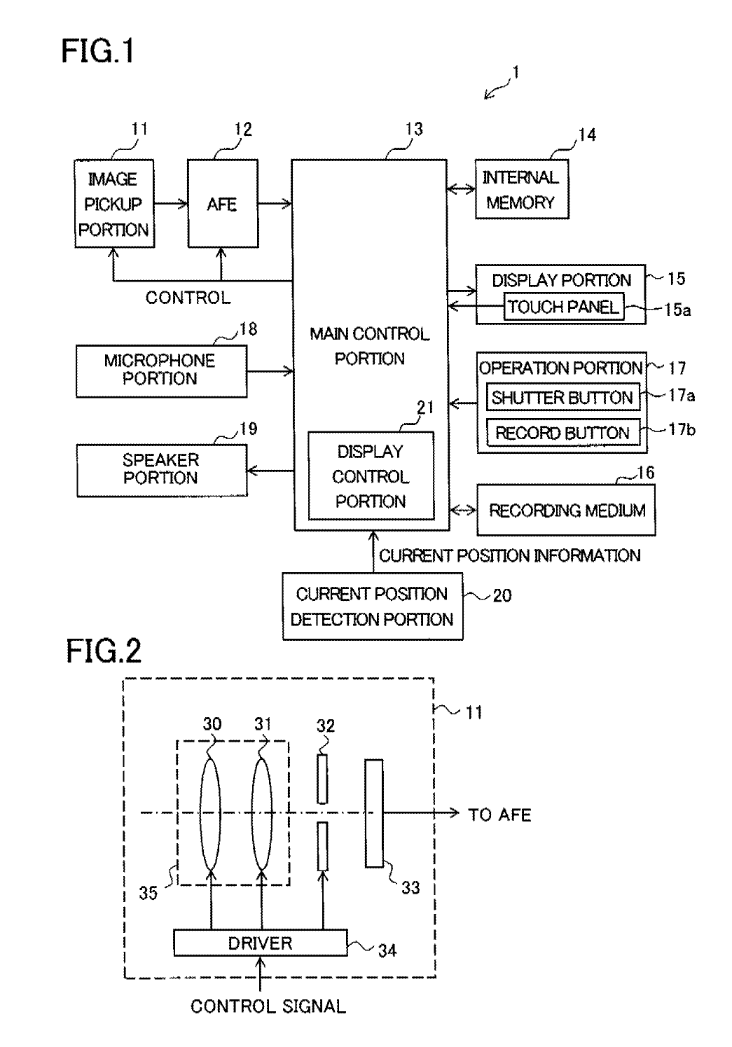

FIG. 1 is a schematic entire block diagram of an image pickup apparatus 1 according to the embodiment of the present invention. The image pickup apparatus 1 is a digital video camera which can photograph and record still images and moving images. However, the image pickup apparatus 1 may be a digital still camera which can photograph and record only still images. The image pickup apparatus 1 includes individual portions denoted by numerals 11 to 20. In this embodiment, unless otherwise noted, photography means photography by an image pickup portion 11 (or the image pickup apparatus 1), and a display and a display screen mean a display and a display screen of a display portion 15.

FIG. 2 is an internal structural diagram of the image pickup portion 11. The image pickup portion 11 includes an optical system 35, an aperture stop 32, an image sensor (solid-state image sensor) 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 for adjusting an angle of view of the image pickup portion 11 and a focus lens 31 for focusing. The zoom lens 30 and the focus lens 31 can move in an optical axis direction. Based on a control signal from a main control portion 13, positions of the zoom lens 30 and the focus lens 31 in the optical system 35, and an opening degree of the aperture stop 32 (namely, an aperture stop value) are controlled. The image sensor 33 is constituted of a plurality of light receiving pixels arranged in horizontal and vertical directions. The light receiving pixels of the image sensor 33 perform photoelectric conversion of an optical image of a subject received through the optical system 35 and the aperture stop 32, and output an electric signal obtained by the photoelectric conversion to an analog front end (AFE) 12.

The AFE 12 amplifies an analog signal output from the image pickup portion 11 (image sensor 33), converts the amplified analog signal into a digital signal, and outputs the digital signal to the main control portion 13. An amplification degree of the signal amplification in the AFE 12 is controlled by the main control portion 13.

The main control portion 13 performs a necessary image processing on an image expressed by an output signal of the AFE 12 and generates a video signal of the image after the image processing. Each of the video signal generated in this portion, the output signal of the image pickup portion 11 (image sensor 33), and the output signal of the AFE 12 is one type of the image signal of the subject. The image expressed by the output signal itself of the AFE 12 or an image obtained by performing a predetermined image processing on the image expressed by the output signal itself of the AFE 12 is referred to as an input image.

An internal memory 14 is constituted of a synchronous dynamic random access memory (SDRAM) or the like and temporarily stores various data generated in the image pickup apparatus 1. The display portion 15 is a display device having a display screen such as a liquid crystal display panel and displays the input image or images recorded in a recording medium 16 under control by the main control portion 13. The display portion 15 is equipped with a touch panel 15a. The user can issue various instructions to the image pickup apparatus 1 by touching the display screen of the display portion 15 with a touching member (a finger or a touch pen). The touch panel 15a may be eliminated. The recording medium 16 is a nonvolatile memory such as a card-like semiconductor memory or a magnetic disk, and records the image signal of the input image and the like under control by the main control portion 13. An operation portion 17 includes a shutter button 17a for receiving a photography instruction of a still image, a record button 17b for receiving a photography start instruction or a photography end instruction of the moving image, so as to receive various operations by the user. The shutter button 17a and the record button 17b may be buttons displayed on the touch panel 15a. Control of display content of the display portion 15 and generation process of an arbitrary image to be displayed on the display portion 15 (for example, a scrapbook image described later) can be performed by a display control portion 21 disposed in the main control portion 13, for example.

A microphone portion 18 converts ambient sounds of the image pickup apparatus 1 into a sound signal as an electric signal and outputs the same. The obtained sound signal can be recorded in the recording medium 16 under control by the main control portion 13. A speaker portion 19 is constituted of one or more speakers and outputs sound of an arbitrary sound signal such as the sound signal recorded in the recording medium 16. A current position detection portion 20 receives transmission signals from the satellites constituting a global positioning system (GPS), and detects a current position (including at least latitude and longitude) of the image pickup apparatus 1 based on the received signal so as to generate current position information indicating a detected current position.

The image pickup apparatus 1 works in any one of a plurality of operation modes, which includes a scenario photography mode and a scenario reproduction mode. In the scenario photography mode, the image pickup apparatus 1 appropriately performs notification (advice) to the user so that photography of still images or moving images is performed along the determined photography scenario. In the scenario reproduction mode, the images photographed along the photography scenario are reproduced. The user in the photography mode including the scenario photography mode is mainly a photographer, and the user in the reproduction mode including the scenario reproduction mode is mainly an operator or a viewer of the image pickup apparatus 1.

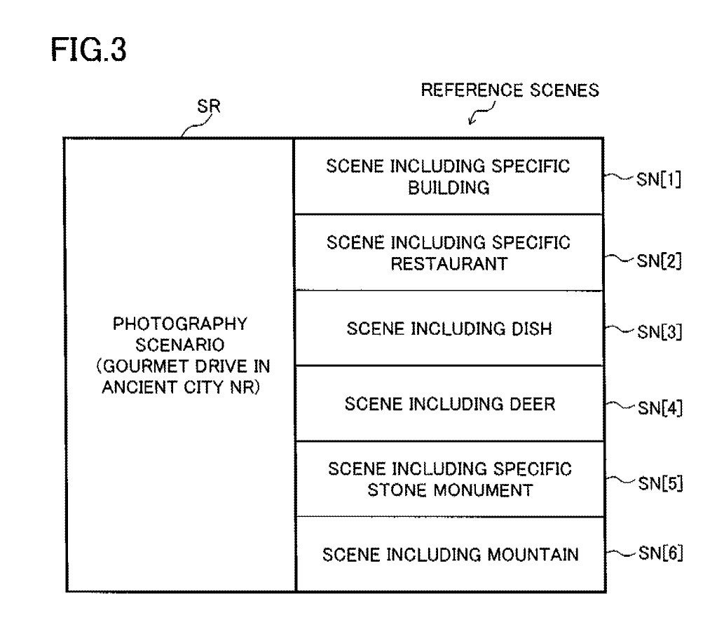

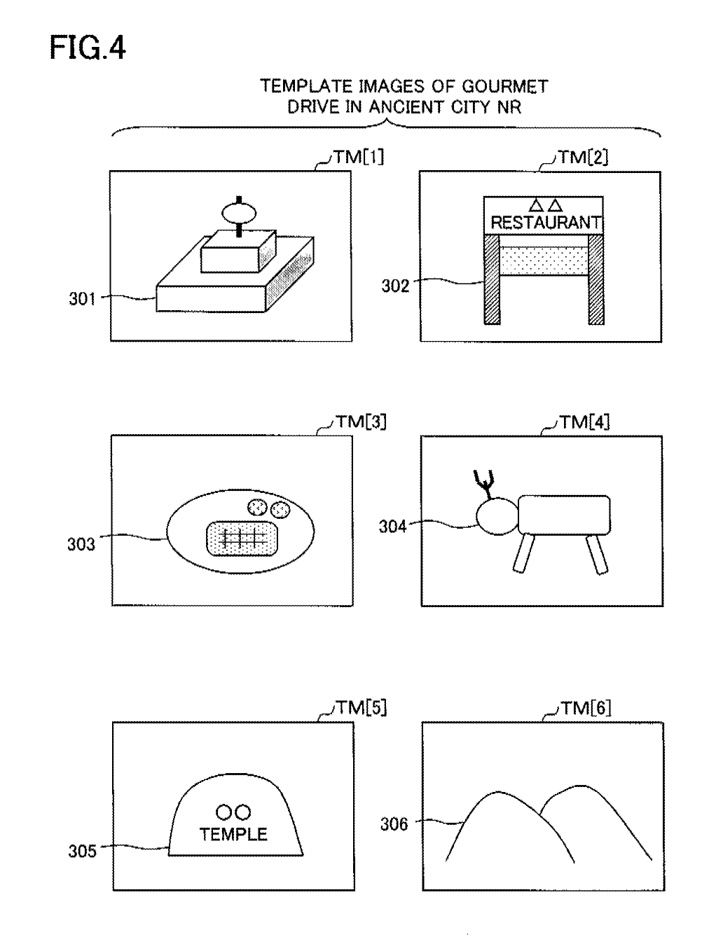

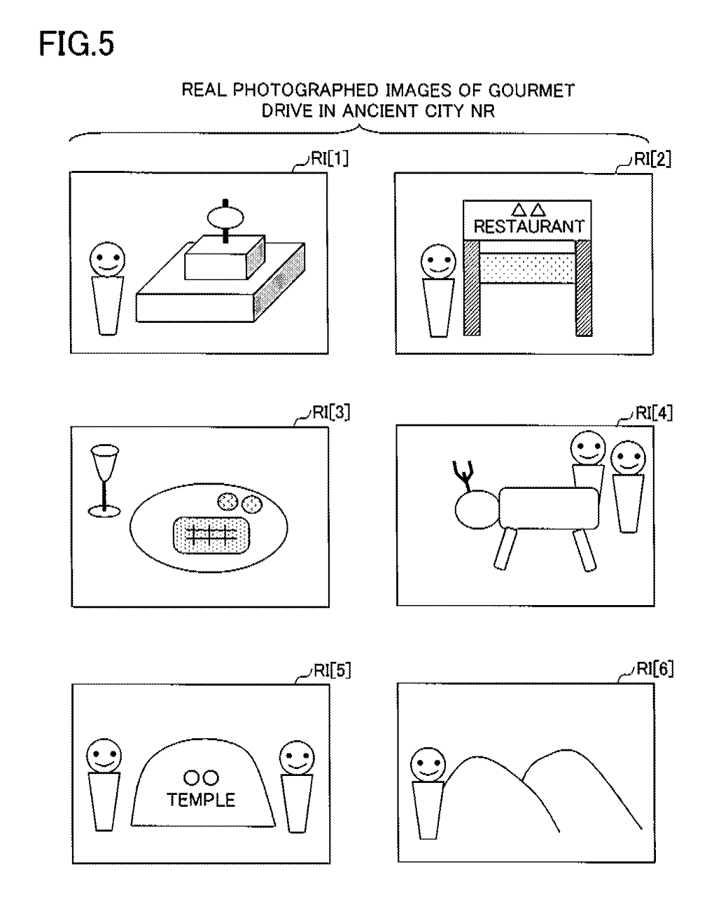

One photography scenario is constituted to include a plurality of reference scenes, and the image pickup apparatus 1 performs the above-mentioned notification at a necessary timing so that an image in each of the reference scenes is photographed. For instance, when a photography scenario SR including reference scenes SN[1] to SN[6] illustrated in FIG. 3 is used, the above-mentioned notification is performed so that real photographed images RI[1] to RI[6] of the reference scenes SN[1] to SN[6] (see FIG. 5) are obtained. FIG. 4 illustrates template images TM[1] to TM[6] corresponding to the reference scenes SN[1] to SN[6]. When the photography images RI[1] to RI[6] are acquired, batch display or the like of the images RI[1] to RI[6] can be performed in the scenario reproduction mode. Details of FIG. 3 to FIG. 5 will be described later.

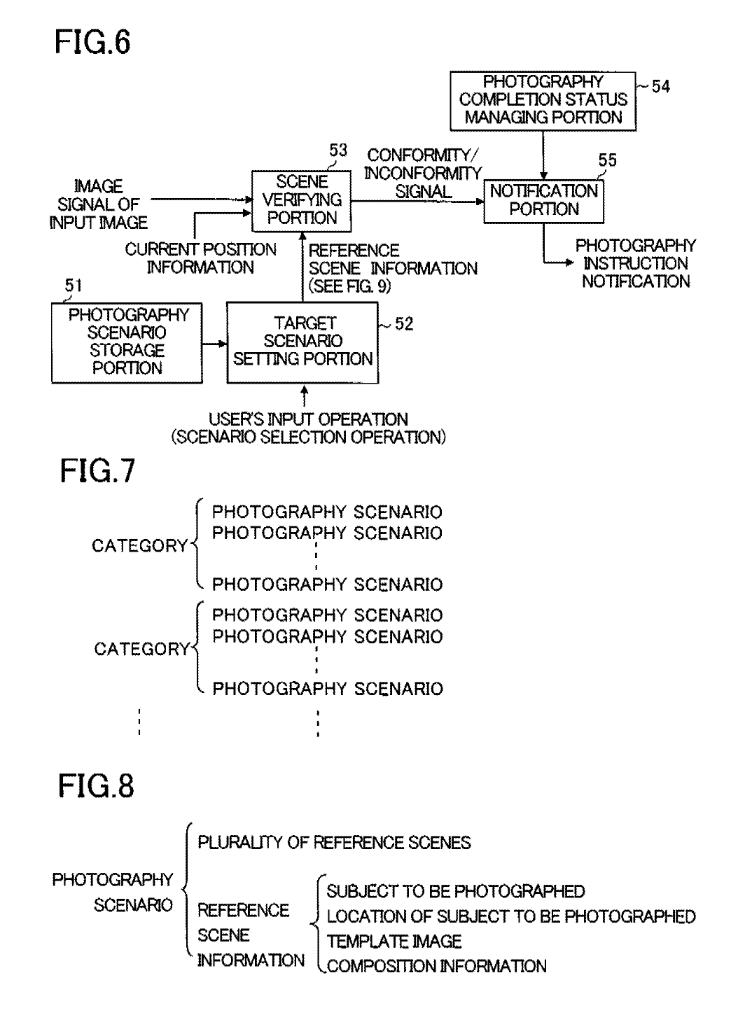

FIG. 6 is a block diagram of a portion particularly related to an action in the scenario photography mode. Individual portions illustrated in FIG. 6 can be disposed in the image pickup apparatus 1 (for example, the main control portion 13).

A photography scenario storage portion 51 is a portion which registers and stores a plurality of photography scenarios. In the stage of designing or manufacturing the image pickup apparatus 1, the photography scenarios to be registered can be determined. Any of the photography scenarios to be registered may be determined by the user who appropriately uses a scenario creating program or the like running on a personal computer. As illustrated in FIG. 7, for example, the registered plurality of photography scenarios may be classified into a plurality of categories. Each of the categories includes one or more photography scenarios. The user can select any one of the photography scenarios belonging to any one of the categories by a predetermined scenario selection operation with the operation portion 17.

Each of the photography scenarios includes a plurality of reference scenes. FIG. 8 illustrates a structure of one photography scenario. Each of the reference scenes defines a scene to be photographed by the image pickup portion 11. As illustrated in FIG. 8, the photography scenario storage portion 51 stores a subject to be photographed (namely, object to be photographed), a location of the subject to be photographed, and the like defined for each reference scene (there is a case where only the subject to be photographed or only the location of the subject is defined). Further, the photography scenario storage portion 51 stores a template image corresponding to each reference scene. A template image of a certain reference scene includes an image of the object to be photographed (subject to be photographed) in the reference scene. The information including the subject to be photographed, the location of the subject, and the template image is referred to as reference scene information. The reference scene information may further include composition information (details of the composition information will be described later). As illustrated in FIG. 8, each photography scenario includes the reference scene information corresponding to itself.

For instance, one photography scenario SR registered in the photography scenario storage portion 51 includes the reference scenes SN[1] to SN[6] as illustrated in FIG. 3, and the template images TM[1] to TM[6] corresponding to the reference scenes SN[1] to SN[6] are recorded in the photography scenario storage portion 51. As a title of the photography scenario SR, for example, “Gourmet drive in ancient city NR” is displayed to the user. With reference to FIGS. 3 and 4, the scene SN[1] is a scene including a specific building 301 as a subject, the scene SN[2] is a scene including a specific restaurant 302 as a subject, the scene SN[3] is a scene including an arbitrary dish 303 as a subject, the scene SN[4] is a scene including an arbitrary deer 304 as a subject, the scene SN[5] is a scene including a specific stone monument 305 as a subject, and the scene SN[6] is a scene including an arbitrary or specific mountain 306 as a subject. For instance, locations of the building 301, the restaurant 302, and the stone monument 305 are included in the reference scene information of the photography scenario SR and are already known by the image pickup apparatus 1.

A target scenario setting portion 52 illustrated in FIG. 6 sets the photography scenario selected by the scenario selection operation to a target scenario among the plurality of photography scenarios registered by the photography scenario storage portion 51, reads the reference scene information of the target scenario from the photography scenario storage portion 51 and sends the same to a scene verifying portion 53.

The scene verifying portion 53 verifies a current photography scene (a scene in a photography area of the image pickup portion 11) with each of the reference scenes of the target scenario. This verifying process is referred to as a scene verify process. The scene verifying portion 53 outputs a conformity signal to a notification portion 55 if the current photography scene conforms to any one of the reference scenes of the target scenario, and otherwise outputs an inconformity signal to the notification portion 55. The scene verifying portion 53 can perform the scene verify process based on at least one of the image signal of the input image and the current position information from the current position detection portion 20, and based on the reference scene information of the target scenario.

A photography completion status managing portion 54 manages a photography completion status of the image corresponding to each of the reference scenes of the target scenario. In other words, the photography completion status managing portion 54 manages whether or not the photography of the reference scene of the target scenario (photography of the image) is completed for each reference scene.

The notification portion 55 performs photography instruction notification for urging the user to acquire the image by photography as necessary based on a result of verification by the scene verifying portion 53 and a result of management by the managing portion 54.

Herein after, unless otherwise noted, it is supposed that the photography scenario SR illustrated in FIG. 3 is set to the target scenario, and actions of the scene verifying portion 53 and the like are described in detail.

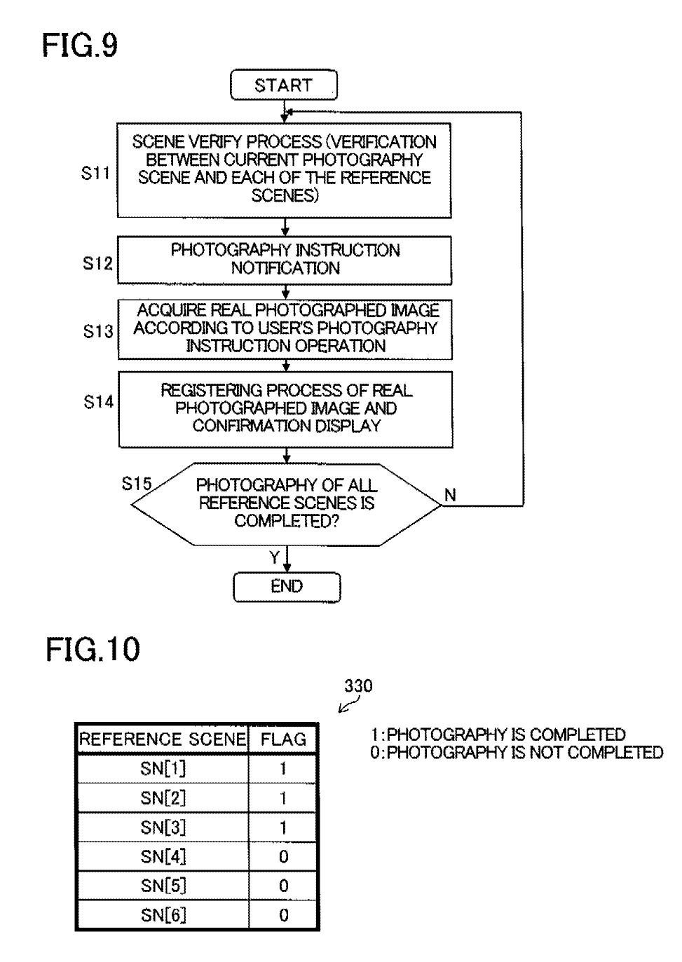

FIG. 9 is a flowchart of an action of the image pickup apparatus 1 after the target scenario is selected in the scenario photography mode. After the target scenario is selected, until photography of all the reference scenes (SN[1] to SN[6]) is completed, the process of Steps S11 to S14 is performed repeatedly.

First in Step S11, the scene verifying portion 53 performs the above-mentioned scene verify process and sends out the conformity or inconformity signal. Some examples of the method of the scene verify process are described.

In a first method example of the scene verify process, the scene verifying portion 53 determines similarity between a template image TM[i] and a whole image or a partial image of the input image by a matching process based on the image signal of the template image TM[i] corresponding to the reference scene SN[i] and the image signal of the current input image. Then, for example, if the similarity is a predetermined reference level or higher, the scene verifying portion 53 decides that the current photography scene conforms to the reference scene SN[i]. Otherwise, the scene verifying portion 53 decides that the current photography scene does not conform to the reference scene SN[i]. The scene verifying portion 53 can perform this branch decision for each reference scene (the same is true in second and third method examples described later). Symbol i denotes an integer.

In the second method example of the scene verify process, the scene verifying portion 53 performs an object detection process for detecting a sort (person, face, dog, cat, vehicle, dish, sea, or the like) of the subject within the photography area of the image pickup portion 11 based on the image signal of the input image, and utilizes a result of the detection by the object detection process so as to decide whether or not the current photography scene conforms to the reference scene SN[i]. If the sort of the subject within the photography area of the image pickup portion 11 conforms to the sort of the subject to be included in the reference scene SN[i], the scene verifying portion 53 can decide that the current photography scene conforms to the reference scene SN[i]. Otherwise, the scene verifying portion 53 can decide that the current photography scene does not conform to the reference scene SN[i].

In the third method example of the scene verify process, it is supposed that the reference scene information of the reference scene SN[i] includes the “location of the subject to be photographed” (see FIG. 8). In the third method example, the scene verifying portion 53 evaluates conformity between the location and the current position information. If the location conforms to the current position of the image pickup apparatus 1, the scene verifying portion 53 can decide that the current photography scene conforms to the reference scene SN[i]. Otherwise, the scene verifying portion 53 can decide that the current photography scene does not conform to the reference scene SN[i].

The scene verify process with respect to an arbitrary reference scene can be realized by any one of the above-mentioned first, second, and third method examples, or a combination of two or more of the method examples. For instance, in the scene verify process with respect to the reference scene SN[3], SN[4], or SN[6], the above-mentioned first or second method example can be used. In the scene verify process with respect to the reference scene SN[2], the above-mentioned first, second, or third method example can be used. In the scene verify process with respect to the reference scenes SN[1] and SN[5], the above-mentioned third method example can be used.

The managing portion 54 keeps management information 330 for each reference scene, which indicates whether or not the photography of the reference scenes SN[1] to SN[6] is completed as illustrated in FIG. 10, for example. The management information 330 is an example of a result of the management by the managing portion 54.

If a conformity signal is sent out for any of the reference scenes SN[i], the notification portion 55 performs the photography instruction notification in accordance with the conformity signal in Step S12 following Step S11. In this case, the notification portion 55 performs the photography instruction notification based on the management information 330 and the conformity signal only if the current photography scene conforms to the reference scene for which the photography is not performed. In order to realize this, it is preferred that the conformity signal from the scene verifying portion 53 should include information indicating which reference scene the current photography scene conforms to. Alternatively, it is possible to give the management information 330 to the verifying portion 53 so that the scene verify process in Step S11 is performed only for the reference scene for which the photography is not performed.

In Step S13 following Step S12, after recognizing the photography instruction notification, the user performs a predetermined photography instruction operation to the operation portion 17. The photography instruction operation is an operation of pressing the shutter button 17a or the record button 17b. The photography image of the image pickup apparatus 1 obtained by the photography instruction operation is referred to also as a real photographed image, in particular (see FIG. 5). After the pressing operation of the shutter button 17a, the image pickup apparatus 1 acquires one or more still images based on the image signal of the input image as the real photographed image. If the photography instruction operation is the pressing operation of the record button 17b, the image pickup apparatus 1 acquires a moving image as the real photographed image, which includes a plurality of frame images that are a plurality of input images obtained in a period from a first pressing operation of the record button 17b until a second pressing operation of the same. The real photographed image is recorded in the recording medium 16. In this case, the real photographed images RI[1] to RI[6] corresponding to the reference scenes SN[1] to SN[6] can be associated to each other and can be recorded in the recording medium 16.

After Step S13, via a registering process of the real photographed image and a confirmation display in Step S14, the managing portion 54 decides whether or not the photography of all the reference scenes SN[1] to SN[6] is completed (Step S15). If the photography of all the reference scenes SN[1] to SN[6] is not completed, the process goes back from Step S14 to Step S11, and the process of Steps S11 to S14 is performed again. The process of Step S14 will be described later.

For instance, it is supposed that the photography instruction notification for the reference scene SN[i] is performed, and the real photographed image RI[i] is acquired in accordance with the photography instruction operation. Then, the image pickup apparatus 1 accepts a predetermined confirmation operation from the user in the operation portion 17 in a state where the real photographed image RI[i] is displayed on the display portion 15. When the operation portion 17 receives the confirmation operation, the managing portion 54 decides that the photography of the reference scene SN[i] is completed (namely, the real photographed image RI[i] is acquired), and can update the management information 330 in FIG. 10 in accordance with the decision content. Alternatively, for example, when the photography instruction notification for the reference scene SN[i] is performed and the real photographed image is acquired in accordance with the photography instruction operation, the image pickup apparatus 1 determines similarity between the real photographed image and the template image TM[i]. It is possible that the managing portion 54 decides that the photography for the reference scene SN[i] is completed if the determined similarity is a predetermined reference level or higher. Similarly to this, it is possible to adopt the following structure, for example. When the photography instruction notification for the reference scene SN[i] is performed and the real photographed image is acquired in accordance with the photography instruction operation, the image pickup apparatus 1 extracts a feature quantity of the real photographed image and compares the extracted feature quantity with a feature quantity of a subject to be included in the reference scene SN[i] (the feature quantity can be set in the reference scene information in advance). Based on a result of the comparison, the managing portion 54 decides whether or not the photography of the reference scene SN[i] is completed.

By the above-mentioned process, for example, after setting the target scenario, first photography instruction notification is performed in a situation where the specific building 301 is within the photography area of the image pickup portion 11 or in a situation where the specific building 301 can be within the same. Then, in accordance with the photography instruction operation responding to the first photography instruction notification, the real photographed image RI[1] is acquired (see FIGS. 4 and 5). After that, when the user reaches the specific restaurant 302, the second photography instruction notification is performed. In accordance with the photography instruction operation responding to the second photography instruction notification, the real photographed image RI[2] is acquired. After that, in the same manner, the real photographed images RI[3] to RI[6] can be acquired.

As described above, in the scenario photography mode, the image pickup apparatus 1 issues the photography instruction notification at a timing suitable for a desired scenario. Thus, missing of photography occasion of the scene along the desired scenario is prevented. The user should perform the photography operation in accordance with the photography instruction notification. Thus, images having a story (narrative images) along the photography scenario “Gourmet drive in ancient city NR” can be collected. In the scenario reproduction mode, for example, a plurality of real photographed images are displayed simultaneously or are displayed as a slide show, and hence the viewer can view the images having a story (narrative images). In this way, according to this embodiment, even if the user has no special knowledge about the photography and edit, it is easy to acquire desired images (for example, impressive images or non-tedious images for the viewer).

Hereinafter, a detailed action example or structure example, or technique related to the same based on the above-mentioned structure and action of the image pickup apparatus 1 is described with reference to a plurality of examples. It is possible to combine two or more arbitrary examples among the plurality of examples described below as long as no contradiction arises.

### First Example

### Screen for Selection of Target Scenario

A first example is described. As described above, the user can select the target scenario from the registered plurality of photography scenarios. When the scenario selection operation is received, the display control portion 21 can display content of each registered photography scenario on the display portion 15, and the user can select the target scenario after viewing the display content.

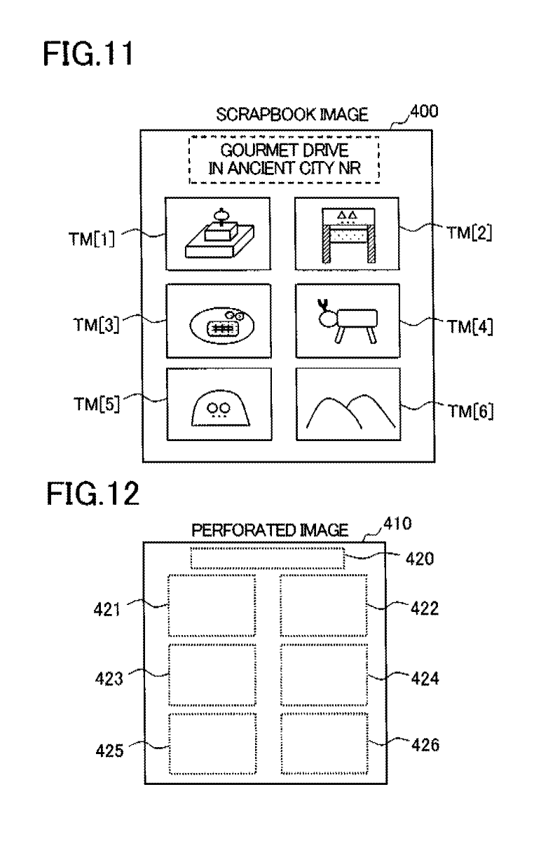

For instance, a display of the content of the photography scenario SR as one of registered photography scenarios can be realized by displaying a scrapbook image 400 (see FIG. 11). The scrapbook image 400 is an image including a title of the photography scenario SR “Gourmet drive in ancient city NR” and template images TM[1] to TM[6]. An image 410 of FIG. 12 is perforated image to be a base of the scrapbook image. The perforated image 410 is a rectangular image, in which an area 420 for the title of the photography scenario SR and six areas 421 to 426 are set (here, the perforated image 410 may have an outer shape other than the rectangular shape). The title of the photography scenario SR “Gourmet drive in ancient city NR” is fit in the area 420 of the perforated image 410, and the template images TM[1] to TM[6] are fit in the area 421 to 426 of the perforated image 410, so as to obtain the scrapbook image 400.

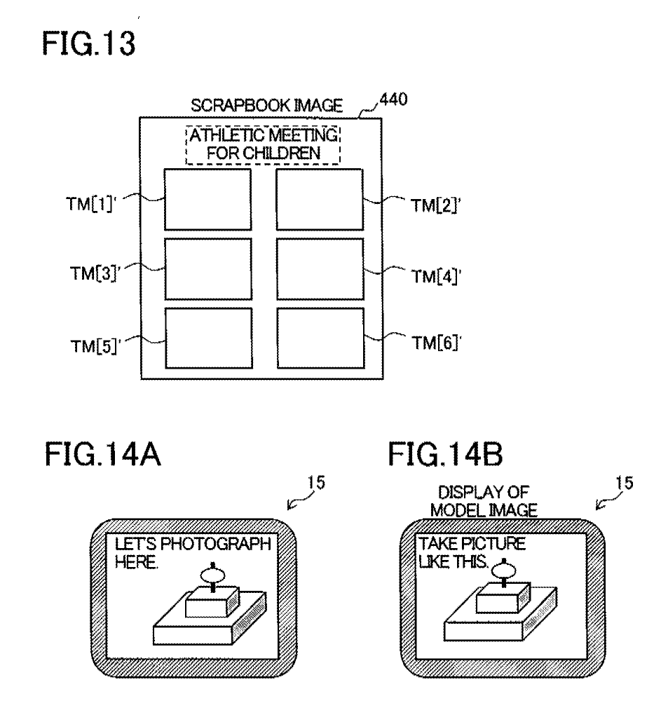

The user can select and designate the photography scenario SR as the target scenario after checking display content of the scrapbook image 400. In the state where the scrapbook image 400 is displayed, a predetermined operation is performed with the operation portion 17. Then, the scrapbook image for other registered photography scenario is displayed, and the other registered photography scenario can be selected and designated as the target scenario by the scenario selection operation. An image 440 of FIG. 13 is an example of the scrapbook image for the other registered photography scenario (In FIG. 13, contents of template images TM[1]′ to TM[6]′ belonging to the other registered photography scenario are omitted). With this structure in which the scrapbook image can be displayed, the user can be informed in advance about the entire image of the scenario that can be obtained by the photography operation in the scenario photography mode.

Note that the number of the template images included in the scrapbook image 400 (or 440) may be any number of two or larger (However, it is also possible that the number is one). If the number of the reference scenes belonging to the photography scenario is substantially large, it is possible to use a scroll display or the like to display all the template images. When an arbitrary image is displayed, the display control portion 21 can perform resolution conversion of the image (enlargement or reduction of the image size) as necessary.

### Second Example

### Photography Instruction Notification

A second example is described. The photography instruction notification is an arbitrary notification for the user's five sense so as to urge the user to photograph images for the reference scene. For instance, the photography instruction notification may be a notification by an image or sound using the display portion 15, the speaker portion 19, or the like. Alternatively, the photography instruction notification may be performed by lighting or blinking a light emitting device (not shown) disposed on the image pickup apparatus 1. An example of the display screen when the photography instruction notification is performed by an image is illustrated in FIG. 14A. Note that in the diagram illustrating content example of the display screen including FIG. 14A, a hatching area indicates a case portion of the display portion 15. In addition, it is possible to adopt a structure in which the image pickup apparatus 1 can communicate with an electronic apparatus (not shown) other than the image pickup apparatus 1, and the notification portion 55 uses the communication to send an instruction to the electronic apparatus so that the real photography instruction notification is performed on the electronic apparatus. Note that if the image pickup apparatus 1 is in a sleep state or in a standby state, it is useful to adopt the above-mentioned photography instruction notification by sound, or the photography instruction notification using the light emitting device or the electronic apparatus other than the image pickup apparatus 1. If the image pickup apparatus 1 is in the sleep state or in the standby state, the action of generating the image signal in the image pickup apparatus 1 and the display action of the display portion 15 are stopped. In this case, the scene verify process based on the current position information and the reference scene information (see FIG. 8) can be performed.

When the photography instruction notification is performed, the display control portion 21 may display the input image at that time point on the display portion 15, or may display an image matching with the corresponding reference scene when the photography instruction notification is performed so as to inform the user about which scene and by which composition the photography should be performed. For instance, it is supposed that the conformity signal corresponding to the reference scene SN[1] is output and that the photography instruction notification is performed for urging to photograph the image for the reference scene SN[1]. Then, as illustrated in FIG. 14B, the photography instruction notification may be performed by the image display, and a model image may be displayed. The model image may be the template image TM[1] or may be a similar image to the template image TM[1]. The similar image may be recorded in the recording medium 16. In addition, the similar image may be an image photographed in the past by a photographer other than the current photographer.

### Third Example

### Composition Change Notification

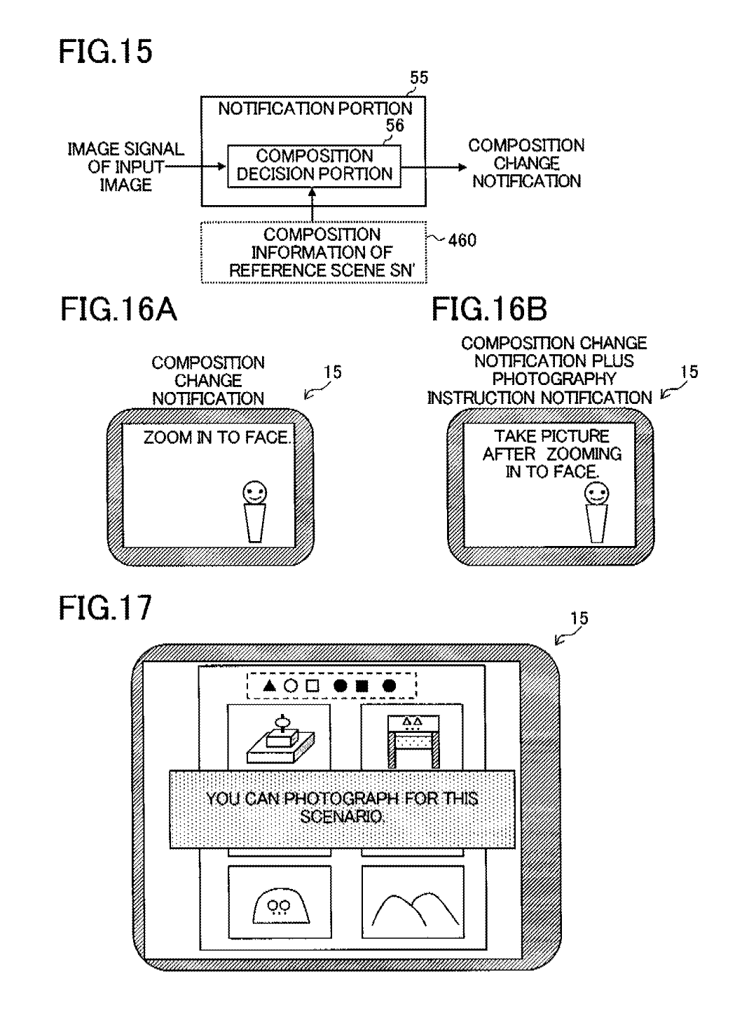

A third example is described. When the photography instruction notification for the reference scene SN[i] is performed, the image pickup apparatus 1 may decide a composition suitable for the reference scene SN[i] so as to urge to change the composition as necessary. This decision may be performed by a composition decision portion 56 that can be disposed in the notification portion 55 (see FIG. 15). The decision of the composition requires composition information that can be included in the reference scene information (see FIG. 8). The composition information is information accompanying any of reference scenes. Here, it is supposed that a composition information 460 accompanies a specific reference scene SN′ that can be any one of the reference scenes SN[1] to SN[6] (see FIG. 15).

The composition information 460 defines photography composition to be adopted when photographing the reference scene SN′. When the photography instruction notification is performed for the reference scene SN′, the composition decision portion 56 decides the current photography composition (in the photography by the image pickup portion 11) based on the image signal of the input image at that time point, and compares the current photography composition (hereinafter referred to as a real photography composition) with the photography composition defined in the composition information 460 (hereinafter referred to as a recommended photography composition), so as to perform the composition change notification for making the real photography composition match with the recommended photography composition. However, if the matching is already obtained, the composition change notification is not necessary. Similarly to the photography instruction notification, the composition change notification may have an arbitrary form.

For instance, if the reference scene SN′ is a scene including a human face as a subject, and if the composition information 460 defines a size, position or orientation of the face on the input image, it is preferred to perform the composition change notification so as to conform to the defined content. More specifically, for example, if the face size in the input image of the current real photography composition is smaller than a face size defined in the recommended photography composition, it is preferred that the notification portion 55 should work together with the display control portion 21 so as to display the current input image together with a message “Zoom in to the face” or “Take picture after zooming in to the face” (see FIGS. 16A and 16B). The same is true for a position or orientation of the face. In this case, it is possible to display a guideline indicating a normal size, a normal position, or the like of the recommended photography composition. The display may be replaced with a sound output. The above-mentioned “face” for the composition change notification may be an arbitrary type of object other than the face (dog, cat, building, or the like).

In addition, for example, in the case where the title of the target scenario is “First trip of child” or the like, if the reference scene SN′ in the target scenario is a scene including a specific object as a subject and if the recommended photography composition defines to photograph the specific object from eyes of child, it is preferred to perform the composition change notification so as to conform to the defined content. The composition decision portion 56 estimates a height of eye of the image pickup portion 11 in the real photography composition based on the image signal of the current input image, and can perform the composition change notification by image display, sound output, or the like so that the eye height of the real photography composition matches with the eye height defined by the recommended photography composition. By performing this composition change notification, it is possible to acquire the real photographed image matching with the target scenario.

### Fourth Example

### When a Plurality of Target Scenarios are Set

A fourth example is described. It is possible that the target scenario setting portion 52 can set a plurality of photography scenarios as a plurality of target scenarios. In this case, the verifying portion 53, the managing portion 54, and the notification portion 55 can perform the actions described above and later on the individual target scenarios. For instance, it is possible to select a category to which the plurality of photography scenarios belong in a scenario selection operation (see FIG. 7), so that the all photography scenarios belonging to the category as the target scenarios.

In the case where the plurality of target scenarios are set, when the photography instruction notification is performed, it is possible to notify the user about the target scenario for which the photography is performed as illustrated in FIG. 17. A method of the notification can be an arbitrary method. In the example of FIG. 17, by displaying the scrapbook image (for example, the scrapbook image 400 or 440 illustrated in FIG. 11 or 13), the user is notified about the target scenario for which the photography is performed. If a plurality of target scenarios are set, a priority order may be determined among the plurality of target scenarios. It is possible to adopt different contents and methods of the photography instruction notification among the target scenarios having different priority order.

### Fifth Example

### Consideration for Remaining Storage Capacity

A fifth example is described. The real photographed image acquired along the target scenario is recorded in the recording medium 16. If a necessary recording capacity for recording the real photographed image to be acquired along the target scenario in the recording medium 16 is larger than the remaining capacity of the recording medium 16 (data capacity that can be additionally recorded in the recording medium 16), the main control portion 13 can perform a remaining capacity measure so that the former becomes equal to or smaller than the latter.

As a first remaining capacity measure, for example, a resolution (the number of pixels) of the real photographed image to be actually recorded in the recording medium 16 can be reduced from a reference resolution. The above-mentioned “necessary recording capacity” means a recording capacity necessary in the case supposed that the real photographed image is recorded in the recording medium 16 by the reference resolution.

As a second remaining capacity measure, it is possible to remove some reference scenes among the reference scenes for which photography is not performed in the target scenario from the target scenario. It is possible to determine the priority order among the plurality of reference scenes belonging to the target scenario in advance, and to delete the reference scenes in order from one having a lowest priority order. In addition, as described above in the fourth example, if a plurality of target scenarios are set, and if a priority order is determined among the plurality of target scenarios, it is possible not to perform the scene verify process by the verifying portion 53, or not to perform the photography instruction notification by the notification portion 55, for the reference scene of the target scenario having a relatively small priority order.

### Sixth Example

### Registering Process and Confirmation Display of Real Photographed Image

A sixth example is described. In the sixth example, the registering process and the confirmation display of the real photographed image that can be performed in Step S14 of FIG. 9 are described.

If it is decided that the photography of the reference scene SN[i] is completed, the managing portion 54 updates the management information 330 of FIG. 10 in accordance with the decision content in Step S14 so as to register the real photographed image RI[i] that is the photography image of the reference scene SN[i] to the target scenario SR. In this case, it is possible to display the real photographed image RI[i] simply on the display portion 15 as the confirmation display of Step S14. It is also possible to inform the user which part of the target scenario SR the real photographed image RI[i] is reflected on.

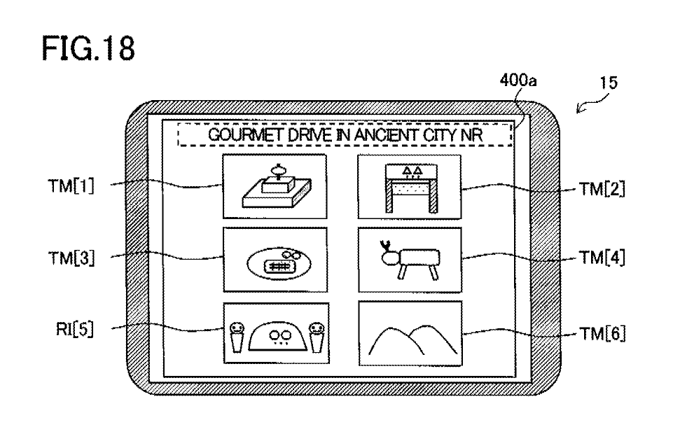

For instance, when the real photographed image RI[5] is acquired with respect to a start point of a state where the photography of the reference scenes SN[1] to SN[6] is not completed, it is possible to display a scrapbook image 400a as illustrated in FIG. 18. The scrapbook image 400a is an image including the title of the photography scenario SR “Gourmet drive in ancient city NR”, the template images TM[1] to TM[4] and TM[6], and the real photographed image RI[5]. By replacing the template image TM[5] of the scrapbook image 400 of FIG. 11 with the real photographed image RI[5], it is possible to obtain the scrapbook image 400a.

The replacement may be realized by actually fitting the image signal of the real photographed image RI[5] in the scrapbook image 400. Alternatively, because the real photographed image RI[5] is recorded in the recording medium 16, the replacement may be realized by making the real photographed image RI[5] on the recording medium 16 link to the scrapbook image 400, and by using the link for applying the image signal of the real photographed image RI[5] to the scrapbook image 400. As described above, when an arbitrary image is displayed, it is possible to perform resolution conversion of the image (enlarging or reducing the image size) as necessary. Therefore, the real photographed image RI[5] in the scrapbook image 400a may be a reduced image of the real photographed image RI[5] (for example, a thumbnail image of the real photographed image RI[5]).

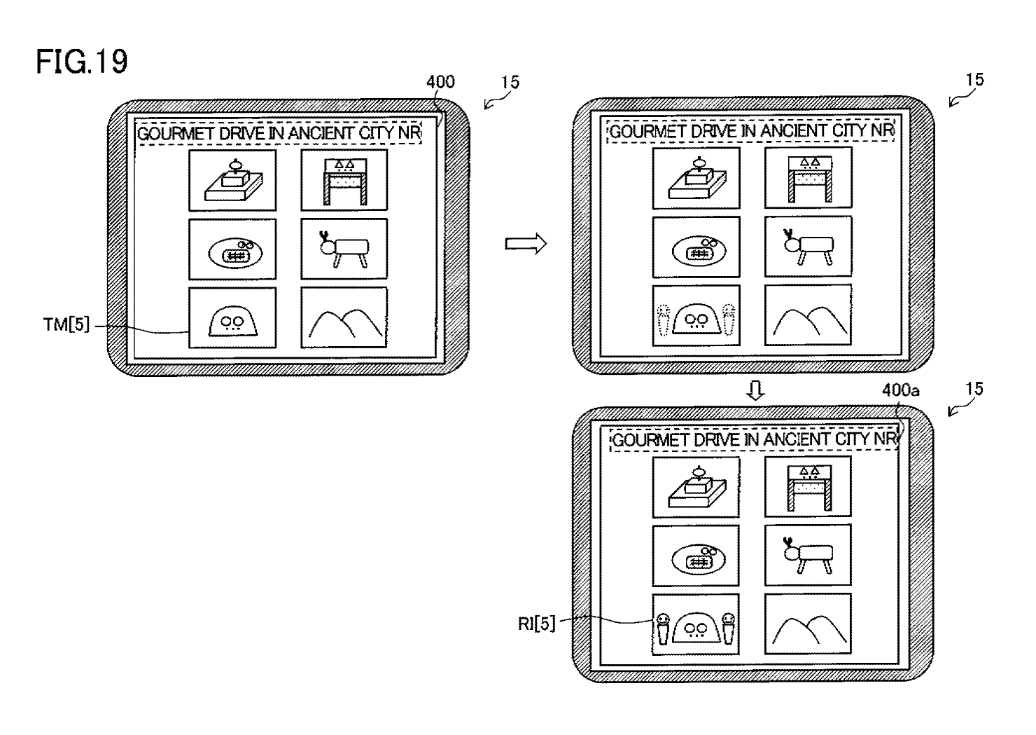

An arbitrary real photographed image is a still image or a moving image. If the real photographed image RI[5] is a moving image, the real photographed image RI[5] in the scrapbook image 400a may be displayed as a moving image (Alternatively, a predetermined frame of the moving image as the real photographed image RI[5] may be displayed as a still image). After the real photographed image RI[5] is acquired, as illustrated in FIG. 19, it is possible to display the scrapbook image 400 first, and to change the display image from the scrapbook image 400 to the scrapbook image 400a gradually during a predetermined period of time.

As described above, when the reference scene SN[i] is photographed so that the real photographed image RI[i] is acquired, the template image TM[i] corresponding to the reference scene SN[i] is replaced with the real photographed image RI[i] on the display portion 15. In particular, by performing the display as illustrated in FIG. 18, the user can confirm which part of the real photographed image is reflected on which part of the target scenario, and can check in real time a manner where real photography results of the target scenario are being collected. Thus, fun of photography operation is improved.

The arbitrary scrapbook image is formed by arranging a plurality of element images, and each element image is a template image or a real photographed image. For instance, the scrapbook image 400 is a scrapbook image including the template images TM[1] to TM[6] as six element images. The scrapbook image displayed after one or more real photographed images are acquired (for example, image 400a) is a scrapbook image including one or more real photographed images in the above-mentioned plurality of element images. The number of element images arranged in one scrapbook image can be any number equal to or large than two.

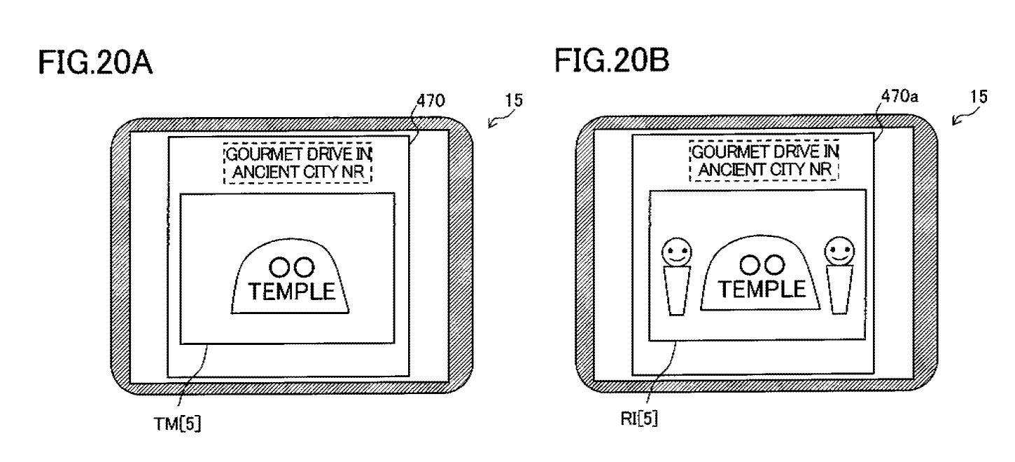

However, it is possible to set one to the number of element images included in the arbitrary scrapbook image. For instance, in the photography scenario storage portion 51 or in the target scenario setting portion 52, any one of reference scenes among the reference scenes SN[1] to SN[6] is determined as a representative scene. Here, it is supposed that the reference scene SN[5] is the representative scene. When the photography scenario SR including the reference scene SN[5] as the representative scene is set as the target scenario, the display control portion 21 may generate a scrapbook image 470 including only one template image TM[5] corresponding to the representative scene so as to display the template image 470 on the display portion 15 (see FIG. 20A). After that, when the real photographed image RI[5] is acquired via the process of Steps S11 to S13 of FIG. 9, the template image TM[5] in the scrapbook image 470 may be replaced with the real photographed image RI[5] so as to generate a scrapbook image 470a as illustrated in FIG. 20B and to display the same (the replacing method is the same as the above-mentioned method). Similarly to FIG. 19, after the real photographed image RI[5] is acquired, the scrapbook image 470 may be first displayed, and the display image may be changed from the scrapbook image 470 to the scrapbook image 470a gradually during a predetermined period of time. The representative scene can function as a front cover or the like of the photography scenario SR. When the display as illustrated in FIG. 20B is performed, the user can recognize that a real photography result of the representative scene is obtained, which can function as a front cover or the like.

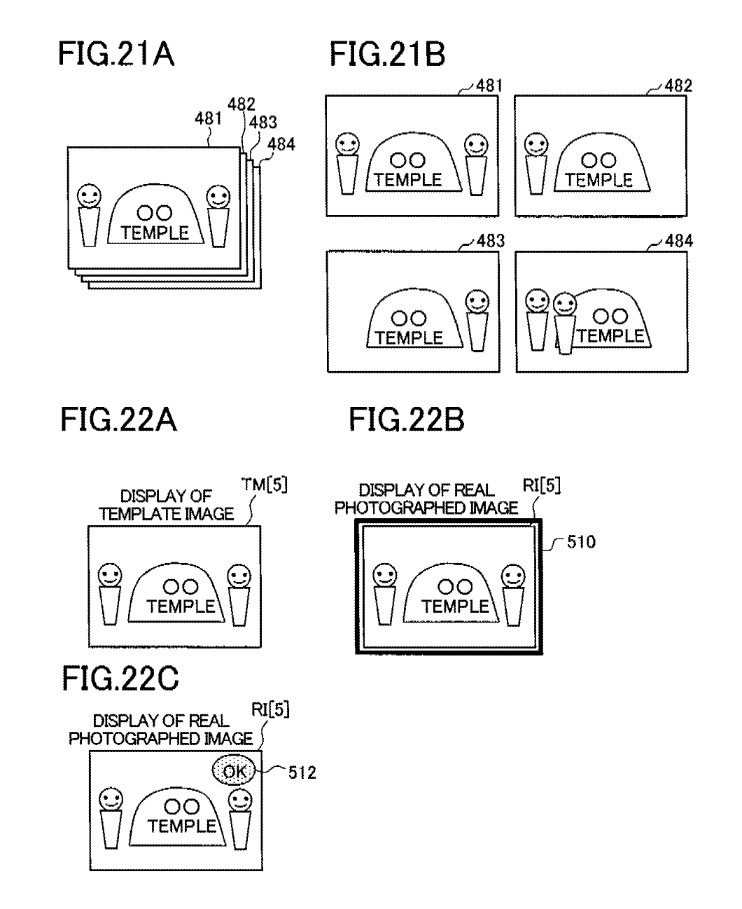

Note that if there are a plurality of real photographed images that can be replaced with the template image TM[5], namely, if it is decided that there are a plurality of real photographed images for the reference scene SN[5], it is possible to perform a display for the user to recognize that there are a plurality of real photographed images for the reference scene SN[5]. For instance, if real photographed images 481 to 484 are acquired as the real photographed image for the reference scene SN[5], it is possible to simultaneously display the images 481 to 484 so as to be overlapped with each other as illustrated in FIG. 21A. Alternatively, it is possible to separate the images 481 to 484 from each other so as to simultaneously display them as illustrated in FIG. 21B. In the state where these displays are performed, the image pickup apparatus 1 may select and determine the real photographed image to be replaced with the template image TM[5] from the images 481 to 484 responding to the user's operation of selecting a target of replacement performed to the operation portion 17.

### Seventh Example

### Display Discrimination Between Template Image and Real Photographed Image

A seventh example is described. In the confirmation display of Step S14, in order that the user can discriminate whether or not the displayed image is not yet photographed, the display control portion 21 may use different display methods for the image that is not yet photographed (namely, the template image) and for the real photographed image. Thus, the user can easily perform the above-mentioned discrimination.

For instance, as illustrated in FIGS. 22A to 22C, when the real photographed image RI[i] is displayed, a predetermined frame 510 or a predetermined icon 512 is assigned to the real photographed image RI[i] to be displayed. On the other hand, when the template image TM[i] as the image that is not yet photographed is displayed, it is possible not to assign the predetermined frame 510 and the predetermined icon 512 to the template image TM[i] (i=5 in FIGS. 22A to 22C). It is possible to assign or not to assign the same in the opposite manner. In addition, for example, when the template image TM[i] as the image that is not yet photographed is displayed, the display control portion 21 or the like may perform a predetermined image processing (for example, a process of reducing gradation or color saturation, or a process of binarize the image signal) on the template image TM[i] so that the template image TM[i] after the image processing is displayed.

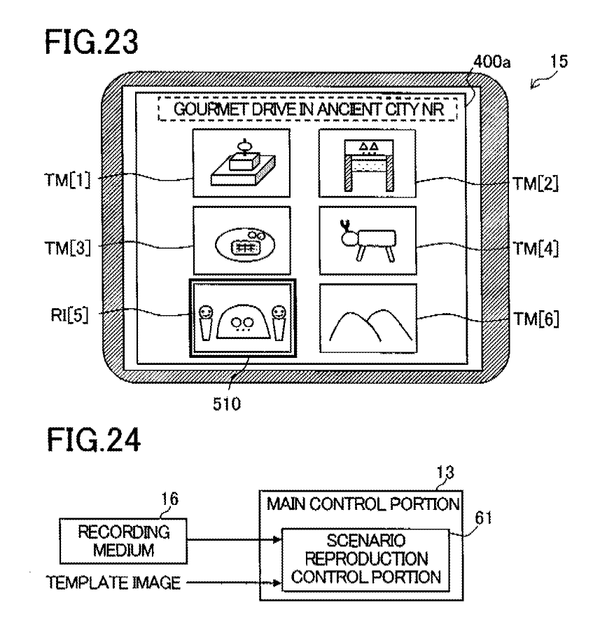

The change of the display method between the image that is not yet photographed and the real photographed image is particularly suitable for displaying the scrapbook image. For instance, when the scrapbook image 400a described in the sixth example is displayed, the display method of the image that is not yet photographed (namely, the template images TM[1] to TM[4] and TM[6]) may be changed from that of the real photographed image RI[5] as illustrated in FIG. 23. In the example of FIG. 23, in the scrapbook image 400a, the predetermined frame 510 is assigned to only the real photographed image RI[5].

### Eighth Example

### Action in Scenario Reproduction Mode

An eighth example is described. In the eighth example, an action of the image pickup apparatus 1 in the scenario reproduction mode is described. It is supposed that photography is performed for some reference scenes of the target scenario SR in the scenario photography mode in advance, and some real photographed images belonging to the target scenario SR are recorded in the recording medium 16. In the scenario reproduction mode, a record content of the recording medium 16 is transmitted to a scenario reproduction control portion 61 disposed in the main control portion 13 (see FIG. 24), and the template image is supplied to the same as necessary (the template image may be recorded in the recording medium 16). It is possible to consider that the scenario reproduction control portion 61 is included in the display control portion 21 of FIG. 1.

In the scenario reproduction mode, when the user instructs to reproduce the target scenario SR, the real photographed image belonging to the target scenario SR is at least reproduced. The reproduction in the scenario reproduction mode means reproduction on an arbitrary reproduction medium (including an image output to the arbitrary reproduction medium). The reproduction medium is the display portion 15, an external display device (such as a television receiver) that is different from the display portion 15 and is connected to the image pickup apparatus 1, or a paper sheet, and further may include an arbitrary medium that can express the image (such as a resin board). The display described in the eighth example means the display portion 15 or a display of an external display device unless otherwise noted. If the reproduction medium is a paper sheet, the scenario reproduction control portion 61 sends out an image signal of an image to be printed on the paper sheet to a printer (not shown) connected to the image pickup apparatus 1. Thus, reproduction of the image on the paper sheet is realized.

The scenario reproduction mode includes a mode MOD_{A} for reproducing only the real photographed image belonging to the target scenario SR as well as a mode MOD_{B} for reproducing a template image, too. In the mode MOD_{B}, if there is a scene for which the photography is not performed yet among a plurality of reference scenes SN[1] to SN[6] belonging to the target scenario SR, the template image corresponding to the scene for which the photography is not performed yet is also reproduced. The user can select the mode MOD_{A} or MOD_{B} by a predetermined operation to the operation portion 17.

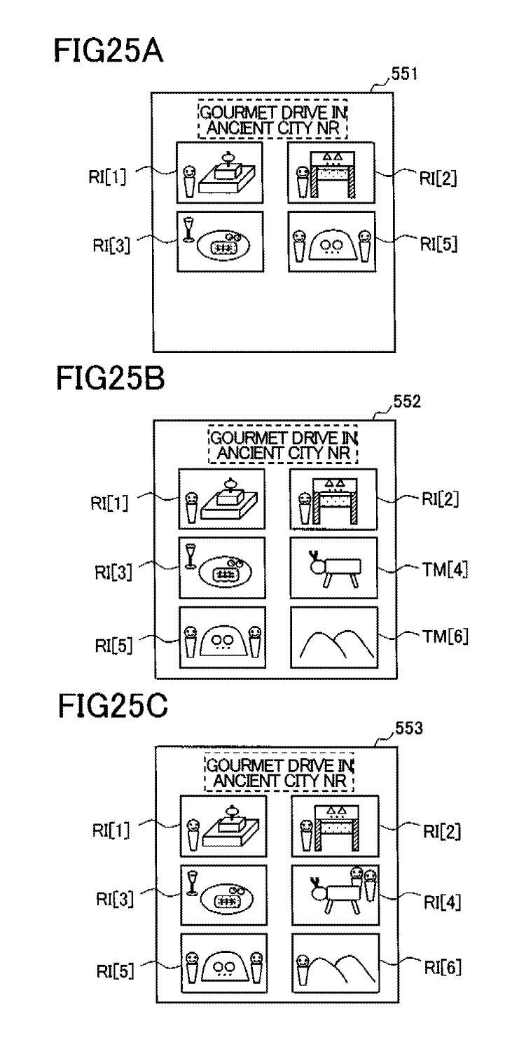

It is supposed that only the real photographed images RI[1], RI[2], RI[3], and RI[5] are acquired as the real photographed images of the target scenario SR and are recorded in the recording medium 16. Under this supposition, when the reproduction is performed in the mode MOD_{A}, the scenario reproduction control portion 61 can generate and reproduce a scrapbook image 551 illustrated in FIG. 25A. When the reproduction in the mode MOD_{B} is performed, the scenario reproduction control portion 61 can generate and reproduce a scrapbook image 552 illustrated in FIG. 25B.

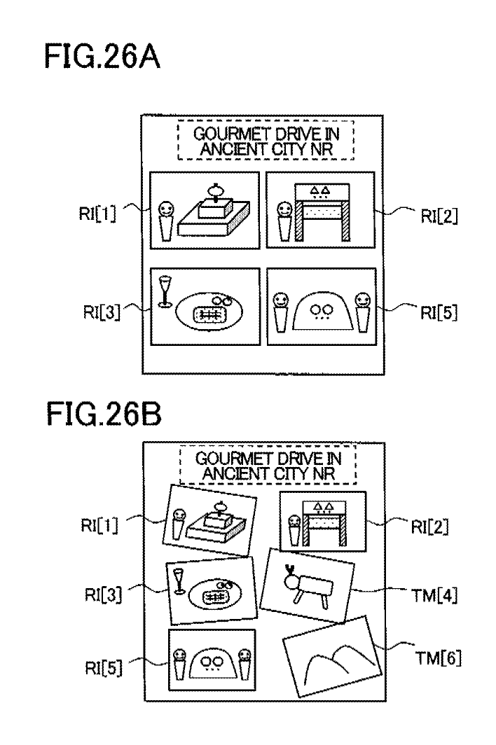

The scrapbook image 551 includes four images RI[1], RI[2], RI[3], and RI[5] as element images and is formed by arranging the same, while the scrapbook image 552 includes six images RI[1], RI[2], RI[3], TM[4], RI[5], and TM[6] as the element images and is formed by arranging the same. Note that although different from the above-mentioned supposition, if all the real photographed images RI[1] to RI[6] are acquired, a scrapbook image 553 constituted by arranging the images RI[1] to RI[6] is reproduced in each of the modes MOD_{A} and MOD_{B} (see FIG. 25C). The scenario reproduction control portion 61 may enlarge or reduce a size (resolution) of the element image to be reproduced in accordance with a size of the reproduction medium as illustrated in FIG. 26A, or may reproduce an arbitrary element image with a tilt on the reproduction medium as illustrated in FIG. 26B. In addition, it is possible to apply the method described above in the seventh example to the reproduction in the mode MOD_{B}, and to change the reproduction method between the image that is not yet photographed and the real photographed image.

In the scenario reproduction mode, the user can perform an operation of designating one of the displayed template images TM[i] or the real photographed images RI[i] (hereinafter referred to as a special reproduction operation) to the operation portion 17. The special reproduction operation can be performed when the scrapbook image is reproduced. When the special reproduction operation is performed, the control portion 61 may enlarge (or reduce) the display of the designated template image TM[i] or the real photographed image RI[i].

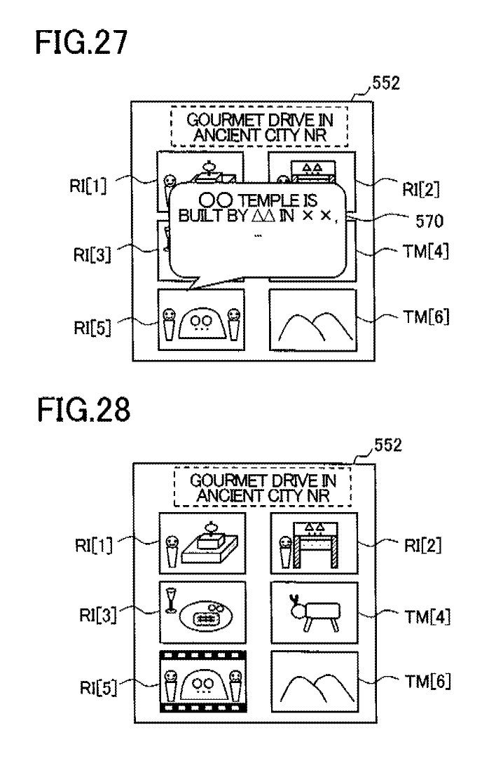

In addition, for example, when the special reproduction operation for designating the template image TM[i] or the real photographed image RI[i] is performed, the control portion 61 may perform reproduction of related information associated with the template image TM[i]. For instance, the related information is stored in the photography scenario storage portion 51 in advance, and the related information is transmitted to the control portion 61 when it is necessary. FIG. 27 illustrates an example of reproduction content when the real photographed image RI[5] is designated by the special reproduction operation in reproduction of the scrapbook image 552. In the example of FIG. 27, related information 570 of the template image TM[5] is superimposed on the scrapbook image 552, but it is possible to reproduce the related information 570 adjacent to the scrapbook image 552. By the reproduction of the related information, it is possible to use the reproduction result as a travel guide book or the like.

In addition, for example, in the case where the real photographed image RI[i] is a moving image, when the special reproduction operation for designating the real photographed image RI[i] is performed, the control portion 61 may reproduce the real photographed image RI[i] as a moving image on the display portion 15 or the external display device. FIG. 28 illustrates an example of reproduction content when the real photographed image RI[5] is designated by the special reproduction operation in reproduction of the scrapbook image 552. Although it is not clear from content illustrated in FIG. 28, the real photographed image RI[5] is reproduced and displayed as a moving image in the example of FIG. 28.

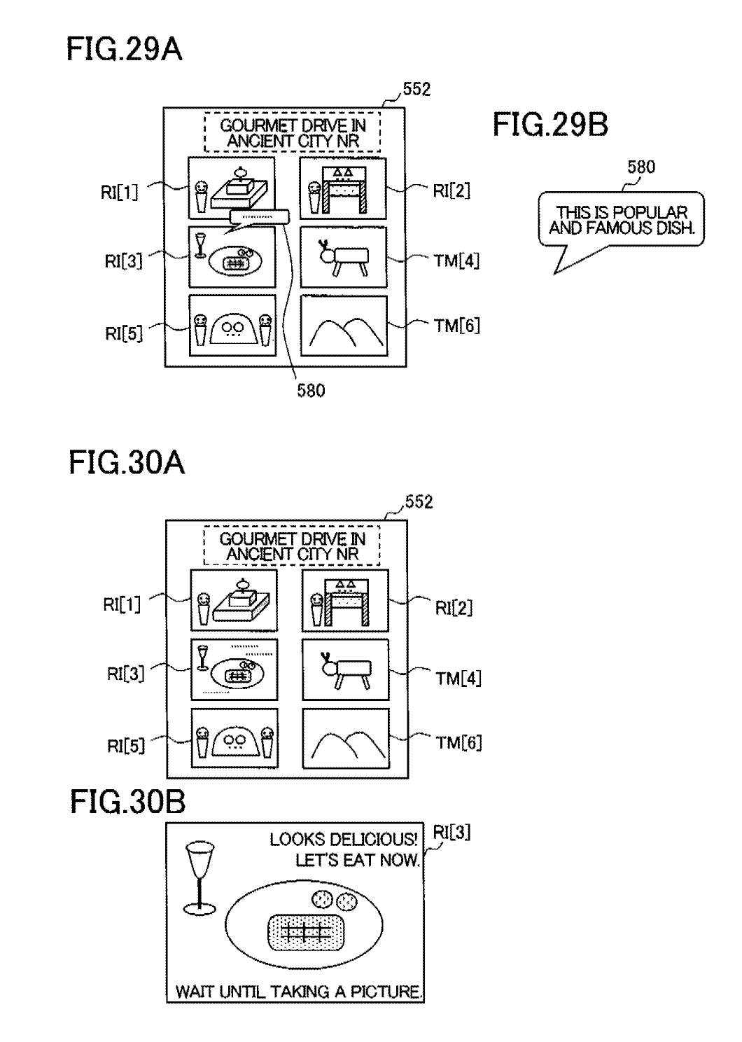

In addition, for example, in a case where the sound information is recorded together with the real photographed image RI[i] in the recording medium 16 when the reference scene SN[i] is photographed (namely, when the real photographed image RI[i] is acquired), when the special reproduction operation for designating the real photographed image RI[i] is performed, the control portion 61 may perform reproduction of the sound information. The sound information may be the output sound signal itself of the microphone portion 18 when the reference scene SN[i] is photographed, or may be a sound signal obtained by performing a predetermined sound signal process on the output sound signal. The sound information may be a sound (a sound memo) recorded by the photographer using the microphone portion 18 before and/or after the photography of the reference scene SN[i]. If the real photographed image RI[i] is a moving image, it is possible to obtain the sound information from the output sound signal of the microphone portion 18 in a photography period of the real photographed image RI[i]. The control portion 61 can extract words of the human voice as text data from the sound signal included in the sound information and can reproduce the text data as reproduction of the sound information. FIGS. 29A and 30A illustrate an example of reproduction content when the real photographed image RI[3] is designated by the special reproduction operation in reproduction of the scrapbook image 552 (It is supposed that the sound information corresponding to the image RI[3] is recorded in the recording medium 16). In the example of FIG. 29A, the sound information of the image RI[3] is reproduced as text data 580 and is superimposed on the scrapbook image 552. FIG. 29B is an enlarged diagram of the text data 580. In the example of FIG. 30A, the text data extracted from the sound information of the image RI[3] is reproduced and superimposed on the image RI[3] of the scrapbook image 552 (The text data may be displayed in order along the time sequence of the sound signal). FIG. 30B is an enlarged diagram of a part of the image RI[3] illustrated in FIG. 30A.

As described above, after completion of the photography of a whole or a part of the reference scenes SN[1] to SN[6], in the scenario reproduction mode, the scenario reproduction control portion 61 can reproduce a plurality of images including one or more real photographed images integrally in the scrapbook image on the reproduction medium. The scrapbook image is an image in which images having a story (narrative images) are grouped. Therefore, even if the user has no special knowledge about editing, the user and/or the viewer can be provided with a desired reproduction result (for example, impressive images or non-tedious images for the viewer).

Note that the scrapbook image to be reproduced may include an arbitrary additional information other than the above-mentioned information. The additional information includes an arbitrary icon, photography date and time of the real photographed image, and the like. The additional information may be reproduced as a so-called pop-up. The photography date and time of the real photographed image may be reproduced for each real photographed image. It is possible to adopt a structure in which the user can select or designate whether or not to reproduce the photography date and time of the real photographed image are together with the real photographed image, in the scenario reproduction mode or in the scenario editing mode described later. If the number of element images belonging to one target scenario is a predetermined number or larger, the element images belonging to one target scenario may be divided into a plurality of scrapbook images for reproduction.

In addition, in the above-mentioned example, a plurality of element images are simultaneously reproduced by reproduction of the scrapbook image, but it is possible to reproduce the plurality of element images in a so-called slide show form. In other words, for example, the plurality of element images belonging to the target scenario may be sequentially reproduced (displayed) one by one, two by two, or N by N in a time division manner (N is a integer larger than two).

In addition, the scenario reproduction control portion 61 can converts the arbitrary scrapbook image into an image file according to an arbitrary standard (for example, an image file or a bit map file according to Joint Photographic Experts Group (JPEG) standard), and the obtained image file can be recorded in the recording medium 16, or can be output to an apparatus that can reproduce the image file (including a printer). In this way, it is possible to reproduce (including to print) the scrapbook image on an apparatus other than the image pickup apparatus 1. If the real photographed image in the scrapbook image to be converted is an thumbnail image, it is preferred to replace the thumbnail image with the real photographed image before performing the conversion. In addition, if the scrapbook image is formed using the “link” described above in the sixth example, it is preferred to change the “link” to “fit in” described above in the sixth example before performing the conversion. When the conversion is performed, there may be non-output data that is not included in the image file. The user can include arbitrary information in the non-output data to be recorded in the recording medium 16. The non-output data can include, for example, photograph data that the user does not desire to be public, a train time table used by the user to go to the ancient city NR, useful comments that the user intends to refer to when going to the ancient city NR next time, and information needed only by the user.

### Ninth Example

### Action in Scenario Editing Mode

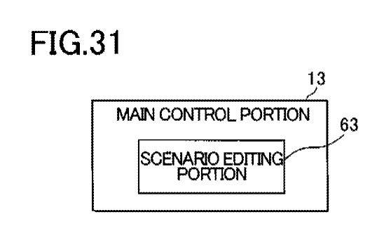

A ninth example is described. In the ninth example, an action of the image pickup apparatus 1 in the scenario editing mode is described. In the scenario editing mode, a scenario editing portion 63 (see FIG. 31) disposed in the main control portion 13 sets the reference scenes to be included in the target scenario in accordance with user's selection/designation operation. The selection/designation operation is performed to the operation portion 17 and includes a deletion operation and an addition operation. When the deletion operation is performed with respect to a reference scene included in the target scenario, the scenario editing portion 63 deletes the reference scene from the target scenario and deletes also the real photographed image or the template image corresponding to the reference scene from the target scenario. If the addition operation is performed with respect to a reference scene that is not included in the target scenario, the scenario editing portion 63 adds the reference scene to the target scenario and adds also the real photographed image or the template image corresponding to the reference scene to the target scenario. In this way, the deletion and the addition of the reference scene are equivalent to the deletion and the addition of the real photographed image or the template image.

The display content when the input of the selection/designation operation is received is arbitrary, but there is described here a method of accepting the input of the selection/designation operation in a state where the scrapbook image of the target scenario SR is displayed.

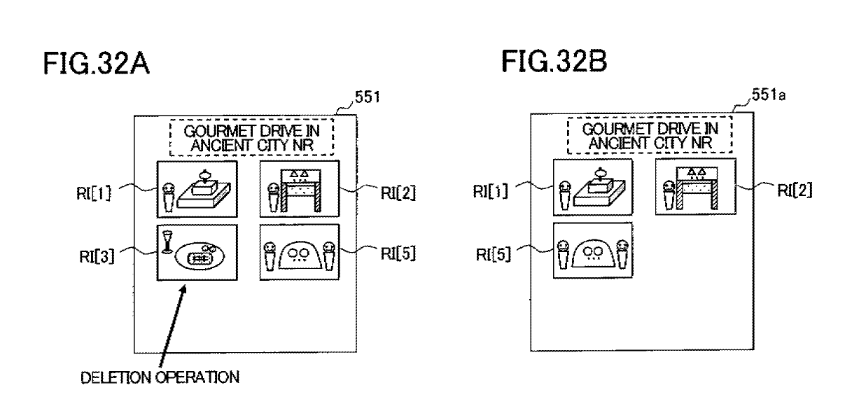

In the state where the photography is performed for some reference scenes of the target scenario SR, and some real photographed images belonging to the target scenario SR are recorded in the recording medium 16, the scenario editing mode can be started. The scenario editing mode in this case may be one type of the scenario reproduction mode. It is supposed that only the real photographed images RI[1], RI[2], RI[3], and RI[5] are acquired as the real photographed images of the target scenario SR and are included in the target scenario SR. Under this supposition, the scrapbook image 551 illustrated in FIG. 32A is displayed under control by the scenario editing portion 63. For instance, when the user performs the deletion operation of the image RI[3], the image RI[3] is deleted from the target scenario SR so that a scrapbook image 551a of FIG. 32B is displayed. After that, when the user performs the addition operation for adding the image RI[3] to the target scenario SR, the image RI[3] is added to the target scenario SR, and the display content backs to that of FIG. 32A. The addition target and the deletion target may be the template image. For instance, in a state where the scrapbook image 552 of FIG. 25B is displayed, namely in a state where the target scenario SR includes the images RI[1], RI[2], RI[3], TM[4], RI[5], and TM[6], if the user performs the deletion operation of the images TM[4] and TM[6], the images TM[4] and TM[6] are deleted from the target scenario SR so that the scrapbook image 551 of FIG. 25A is displayed. After that, when the user performs the addition operation for adding the images TM[4] and TM[6] to the target scenario SR, the images TM[4] and TM[6] are added to the target scenario SR, and the display content backs to that of FIG. 25B.

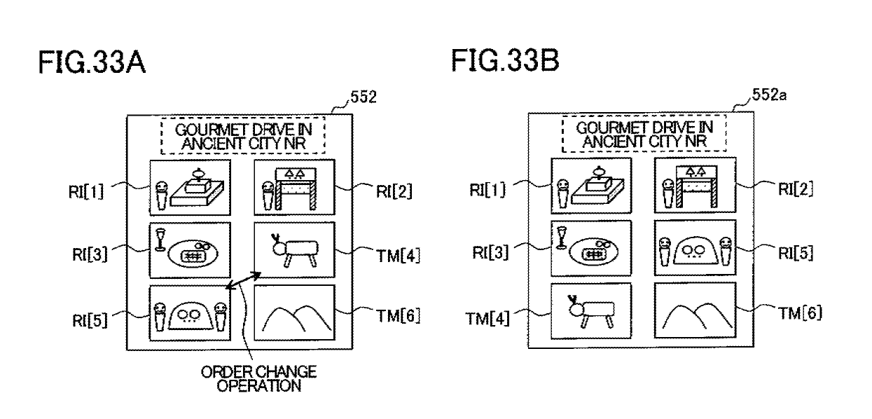

In addition, the scenario editing portion 63 can also change the order (namely, location positions) of the element images (the real photographed images or the template images) on the scrapbook image in accordance with user's order change operation input to the operation portion 17. For instance, when the scrapbook image 552 of FIG. 33A that is the same as that to of FIG. 25B is displayed, the order change operation for exchanging the order (location positions) of the image TM[4] and the image RI[5] is performed, the scrapbook image 552a (see FIG. 33B) after the order exchange is displayed, and the target scenario SR is updated to that after the order exchange (appearance in reproduction is different between the image 552 and the image 552a).

Because the selection/designation operation and the order change operation can be performed as described above, it is possible to create a scenario in which user's taste is considered. The scenario reproduction control portion 61 can reproduce the scrapbook image of the target scenario updated by the selection/designation operation or the order change operation, as the eighth example.

In addition, in a state where no real photography is performed yet for each of the reference scenes of the target scenario SR, the scenario editing mode can be started. In this case, the scrapbook image 400 of FIG. 11 is first displayed. In this state, when the user designates an arbitrary template image and performs the deletion operation or the addition operation, the reference scene corresponding to the designated template image is deleted from the target scenario SR or is added to the target scenario SR. If the template image TM[6] is deleted (namely, the reference scene SN[6] is deleted) from the target scenario SR by the deletion operation, in the scenario photography mode, the scene verifying portion 53 of FIG. 6 does not perform the scene verify process for the reference scene SN[6], and as a result, the photography instruction notification for the reference scene SN[6] cannot be performed. However, in this case too, it is possible to perform the scene verify process for the reference scene SN[6]. If the conformity signal for the reference scene SN[6] is input, and if the photography of the reference scene SN[6] is not completed, the notification portion 55 may provide the user with a recommendation notification different from the photography instruction notification (for example, a notification of inquiring whether or not photography of the reference scene SN[6] is necessary).

In addition, even if no real photography is performed for each of the reference scenes of the target scenario SR, the above-mentioned order change operation is effective. A result of the order change operation is reflected on a reproduction layout of the scrapbook image in the scenario reproduction mode. Without limiting to this, the result of the order change operation may affect the scene verify process.

In this case, as a precondition, an order is assigned in advance to a plurality of reference scenes included in the target scenario SR, for example. Then, after starting the action in the scenario photography mode, the scene verify process is performed for only the reference scene having a first order. After the photography of the reference scene having the first order is completed, the scene verify process is performed for only the reference scene having a second order. Similarly, after the photography of the reference scene having a second order is completed, the scene verify process is performed for only the reference scene having a third order (the same is true for the reference scenes having following orders). By limiting the reference scene to be a target of the scene verify process, improvement of accuracy of the scene verify process can be expected.

In the precondition that the scene verify process along the order is performed, when the above-mentioned order change operation is performed, an order assigned to each of the reference scenes is changed in accordance with the order change operation. If the photographer has decided in advance an order to round a plurality of places corresponding to a plurality of reference scenes, the photographer can perform the order change operation in accordance with the decision content. For instance, if it is decided in advance to go and see deer 304 after visiting the temple with the stone monument 305 (see FIG. 4), the order change operation can be performed so that the order of the reference scene SN[5] is higher than the order of the reference scene SN[4].

<<Variations>>

The embodiment of the present invention can be modified variously as necessary within a scope of the technical concept described in the claims. The embodiment is merely an example of the embodiment of the present invention, and the present invention and meanings of the individual elements are not limited to those described in the embodiment. The specific values shown in the above description are merely examples and can be changed to various values as a matter of course. As annotations that can be applied to the embodiment described above, Notes 1 to 4 are described as below. The contents described in the Notes can be combined arbitrarily as long as no contradiction arises.

[Note 1]

In the above-mentioned embodiment, it is considered that the photography of the reference scene SN[i] is completed mainly when the real photographed image RI[i] is acquired as one still image or one moving image. However, it is possible to adopt a structure in which the photography completion status managing portion 54 of FIG. 6 decides that the photography of the reference scene SN[i] is completed when the reference scene SN[i] is photographed a plurality of times. It is possible that the target scenario setting portion 52 sets in advance the number of times of photographing the reference scene SN[i] for deciding completion of the photography of the reference scene SN[i].

[Note 2]

It is possible to perform the action in the above-mentioned scenario reproduction mode or the scenario editing mode on an electronic apparatus other than the image pickup apparatus 1 (The image pickup apparatus 1 is also one type of the electronic apparatus). The electronic apparatus is equipped with all the portions disposed in the image pickup apparatus 1 or the portions necessary for realizing the action in the scenario reproduction mode or the scenario editing mode among the portions disposed in the image pickup apparatus 1.

[Note 3]

The image pickup apparatus 1 may be one that is mounted in an arbitrary apparatus (a mobile terminal such as a mobile phone).

[Note 4]

The image pickup apparatus 1 of FIG. 1 may be constituted of hardware or a combination of hardware and software. When the image pickup apparatus 1 is constituted of software, the block diagram of a portion realized by the software indicates a functional block diagram of the portion. The function realized by the software may be described as a program, and the program may be executed by a program executing device (for example, a computer) so that the function is realized.

What is claimed is:

1. An image pickup apparatus comprising:
an image pickup portion which generates an image signal of a subject;
a scenario setting portion which sets a photography scenario defining a plurality of reference scenes to be photographed;
a verifying portion which verify photography scene of the image pickup portion with each of the reference scenes;
a managing portion which manages a photography completion status of an image corresponding to each of the reference scenes; and
a notification portion which performs notification corresponding to a result of verification by the verifying portion and a result of management by the managing portion.

2. The image pickup apparatus according to claim 1, wherein the notification includes notification for urging photography by the image pickup portion.

3. The image pickup apparatus according to claim 1, further comprising a display portion which can display one or more template images corresponding to one or more reference scenes among the plurality of reference scenes, wherein
when a target reference scene included in the one or more reference scenes is photographed so that a target photography image is obtained, a template image corresponding to the target reference scene is replaced with the target photography image on the display portion.

4. The image pickup apparatus according to claim 3, wherein
the display portion can display a plurality of template images corresponding to the plurality of reference scenes, and
when the target reference scene included in the plurality of reference scenes is photographed so that the target photography image is obtained, a template image corresponding to the target reference scene is replaced with the target photography image on the display portion.

5. The image pickup apparatus according to claim 4, wherein
the display portion can display a scrapbook image in which two or more element images are arranged,
when all images corresponding to the plurality of reference scenes are not photographed yet, a first scrapbook image including two or more template images included in the plurality of template images as the two or more element images is displayed, and afterward,
when the target photography image is acquired, a second scrapbook image including the target photography image in the two or more element images is displayed.

6. The image pickup apparatus according to claim 1, wherein the verifying portion decides whether or not the photography scene of the image pickup portion conforms to one of the plurality of reference scenes based on at least one of the image signal and current position information of the image pickup apparatus.

7. The image pickup apparatus according to claim 1, wherein the notification portion performs the notification when it is decided that the photography scene conforms to a reference scene for which the photography is not completed based on the result of verification and the result of management.

8. The image pickup apparatus according to claim 1, wherein
the photography scenario includes composition information accompanying a specified reference scene included in the plurality of reference scenes, and
the notification portion urges to change a photography composition of the specified reference scene in accordance with the image signal and the composition information when the notification is performed.

9. The image pickup apparatus according to claim 3, wherein when the display portion displays the target photography image and any of the template images after the target photography image is obtained, a display method is changed between the displayed target photography image and the displayed template image.

10. The image pickup apparatus according to claim 1, further comprising a reproduction control portion which reproduces a plurality of images including a photography image of each of the reference scenes integrally on the reproduction medium after photography of a part or a whole of the plurality of reference scenes is completed.
